(19) United States
(12) Patent Application Publication
(10) Pub. No.: US 2017/0136297 A1
(43) Pub. Date: May 18, 2017

(54) FITNESS MONITORING DEVICE

(71) Applicant: Prince Penie, Syracuse, NY (US)

(72) Inventor: Prince Penie, Syracuse, NY (US)

(21) Appl. No.: 14/941,242

(22) Filed: Nov. 13, 2015

(51) Int. Cl. A63B 24/00; G09B 5/02; G09B 19/00

(52) U.S. Cl. CPC A63B 24/0062; G09B 19/003; G09B 5/02; A63B 24/0021

(57) ABSTRACT

A wearable fitness monitoring device and method of providing motivational feedback during a physical activity, the device comprises a mapping and GPS system configured to determine a first data and having at least one sensor for sensing a second data comprising physiological parameters. The device further comprises a controller for processing the first and second data to output a third data via a display unit or an audio interface. The third data comprises a safety alert when one or more physiological parameters exceeds a predetermined threshold level, a motivational message based on the first data, a hydration alert and a nutritional alert suggesting an amount of calorie intake calculated based on the amount of calories spent.

### FIELD OF THE INVENTION

The present invention generally relates to a fitness-monitoring device and more particularly relates to a wearable fitness device for monitoring athletic and fitness activities and providing motivational feedback to users.

### BACKGROUND OF THE INVENTION

Fitness activities including physical exercises are of vital importance to maintain a healthy lifestyle and individual well-being. Generally, people who engage in athletic activities and physical workout routine prefer to monitor their performance in order to keep track of their progress and training needs. For example, athletic performance is greatly influenced by physiological parameters such as heart rate, oxygen consumption, body weight, etc. Therefore, both physiological parameters and other exercise related parameters such as distance, speed, calories burned needs to be monitored for assisting an individual to achieve one or more goals related to athletic performance or overall fitness.

Recent trends in technology have led to the development of more sophisticated athletic performance monitoring systems and devices. Handheld, portable devices have been designed to keep track of parameters such as distance, time, laps, calories spent, number of steps walked, and the like. With advancement in technology, wearable fitness devices came into existence, which allowed users to wear the device easily while performing athletic or fitness activities. Individual physical performance monitoring devices enable easy and convenient monitoring of speed, distance, altitude data, GPS data, heart rate, pulse rate, blood pressure data, body temperature, etc. However, these devices do not offer motivational feedback regarding the physical or athletic activity monitored.

Existing wearable fitness devices comprises various sensors to assess and monitor athletic performance and level of physical activity performed by the user. These devices typically use GPS technology to calculate metrics like speed, distance, elevation and time. Sensors are incorporated to monitor heart rate, blood pressure, temperature and other physiological parameters in order to provide an indication of performance level. The data recorded in the device can be transferred to a computer or smart phone or mobile device. Some of the devices include additional features including alarm settings, goal settings, activity log and music synchronizing.

However, the existing prior art fitness devices fails to provide motivational feedback based on monitored physical activity and to provide safety alerts in case of excessive energy expenditure or undesired change in vital physiological parameters. In light of aforementioned problems of conventional portable athletic devices, there exists a need for an improved wearable fitness monitoring device comprising functionalities to motivate a user to set and reach personal fitness and athletic goals.

### SUMMARY OF THE INVENTION

The present invention relates to a wearable fitness-monitoring device equipped with enhanced features to boost personal motivation during athletic and fitness activities in addition to monitoring fitness and athletic performance.

According to one aspect of the invention, the wearable fitness-monitoring device comprises a portable housing attached to a cuff wearable by a user during a physical activity. The housing further comprises a mapping and GPS system configured to determine a first data comprising distance, speed, time and route. The device further comprise at least one sensor for sensing a second data comprising one or more physiological parameters and a controller configured to process the first and second data to output a third data via a display unit or an audio interface. The third data comprises a safety alert when the second data exceeds a predetermined threshold level, a motivational message based on the first data, and a nutrition alert about an amount of calorie a user should intake which is calculated based on the amount of calories burned.

The third data may also comprise a break alert in between fitness activities and a hydration alert indicating a need for rehydration, which is estimated based on duration and intensity of the physical activity. In an embodiment, the safety alert may comprise an audio alert warning to stop the physical activity, a vibrational alert to warn user about a risk level calculated based on the second data and automatic shutdown of the device when the safety alerts are ignored by the user.

According to another aspect of the invention, the wearable fitness-monitoring device comprises a plurality of control buttons for inputting user settings. Using control buttons, the user can set goals, preferences, alerts and activity mode. The motivational message provided by the wearable fitness-monitoring device indicates an amount of progress achieved towards a set goal. The device further comprises a communication interface for connecting to an external device such as mobile device, laptop, smartphone and the like. The communication interface may comprise wired or wireless connection for transferring data to the external device. In an embodiment, the first and second data can be stored in the device memory and/or transferred to a remote server.

Further embodiments, features, and advantages of the present invention, as well as the structure and operation of the various embodiments of the present invention, are described in detail below with reference to the accompanying drawings.

### BRIEF DESCRIPTION OF DRAWINGS

FIG. 1 is perspective view of the wearable fitness-monitoring device.

FIG. 2 is a schematic block diagram of a wearable fitness-monitoring device according to an embodiment of the present invention.

FIG. 3 illustrates an example of the break alert displayed by wearable fitness monitoring device during athletic performance in accordance with this invention.

FIG. 4 illustrates an example of the safety alert displayed according to an embodiment.

FIG. 5 illustrates an example of the nutritional message displayed according to an embodiment of this invention.

FIG. 6 illustrates an example of a hydration alert displayed during one of the activity mode.

FIG. 7 is a flow chart of a method of providing a motivational feedback based on the user activity in accordance with the present invention.

### DETAILED DESCRIPTION OF THE INVENTION

The following detailed description of different exemplary embodiments presents a description of certain specific embodiments to assist in understanding the claims. However, the present invention is intended to cover alternatives, modifications and equivalents, which may be included within the spirit and scope of the invention as defined by the appended claims.

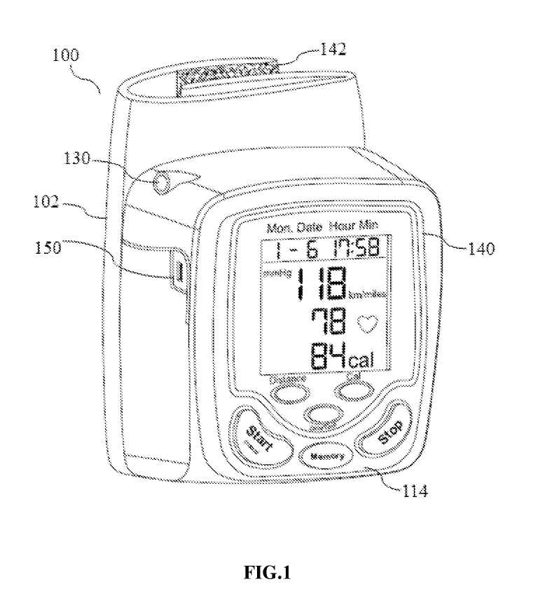

According to the present invention, as depicted in FIG. 1, the wearable fitness-monitoring device 100 is a wearable smart high tech device designed to boost personal motivation during athletic and personal health, fitness activities. The device 100 comprises a portable housing 102 attached to a cuff 142 wearable by a user during a physical activity, the housing 102 comprises a plurality of components for the functioning of the device 100. The wearable fitness-monitoring device 100 further comprises a communicating interface 150 to transfer the measured parameters.

The device 100 further comprises an audio interface 130 and a display unit 140 to display the measured parameters to the user during the fitness activity. The functional keys 114 acts as a control buttons for user to set the goal and input user settings. The functional keys 114 may comprise a stop button and a start button; the start button may also be utilized as a power button. It is also understood that the power/start button positioned on the opposite side of the stop button, which may be fixed anywhere in the wearable fitness monitoring device 100.

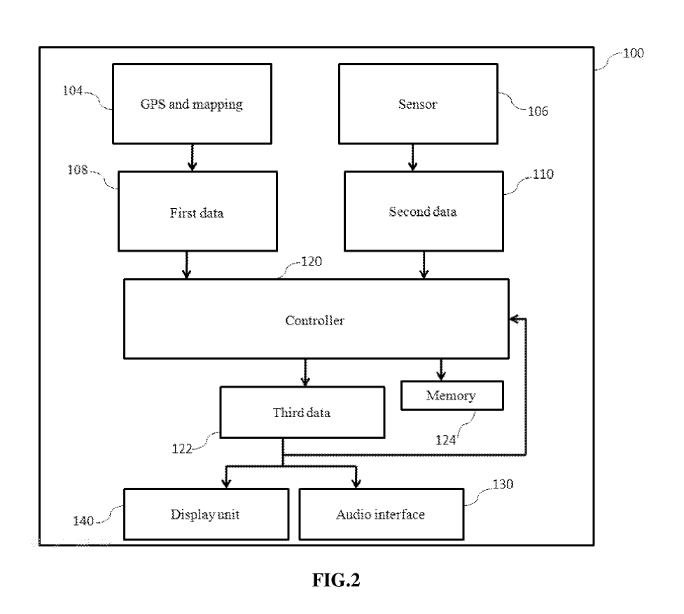

FIG. 2 shows a block diagram of the wearable fitness monitoring device 100 comprising different components. The device 100 comprises a mapping and GPS system 104 configured to determine a first data 108, which comprises distance, time, speed and route. The device 100 further comprises at least one sensor 106 for sensing a second data 110 comprising physiological parameters such as heart rate, blood pressure and oxygen consumption. A controller 120 configured to process the first data 108 and second data 110 to output a third data 122, which comprises a safety alert, wherein the safety alert is displayed when the second data 110 exceeds a predetermined threshold level. The third data 122 further comprises a motivational message provided based on user's performance and one or more goals set by the user. The third data 122 further comprise a nutrition alert suggesting an amount of calorie intake either by displaying in display unit 140 or through audio interface 130 to the user. The amount of calorie intake is calculated based on the amount of calories spent as sensed by the device 100 during a fitness or athletic activity. The third data 122 further comprise a break alert, suggesting the user to take a timed break in between workouts. The data sensed by the sensor, mapping module and the data calculated by the controller are stored in a memory 124 of the wearable fitness-monitoring device 100.

In an exemplary embodiment, the communication interface 150 is configured to connect and transfer measured parameters such as first data 108, second data 110 and the third data 122 through a wired or wireless means of communication to an external device. The data transmission portion configured to connect directly or indirectly with another external device. The external device comprises a server, a mobile device, a smartphone, a media content player, a personal digital assistant (PDA) and a personal computer. It is further understood that the wearable fitness-monitoring device 100 can be configured to communicate and transfer data from a data transfer member such as the communication interface 150, or completely via wireless communication, or a combination of both wireless communication and various types of plug-in communication.

The wearable fitness-monitoring device 100 promotes individualized health and fitness activities, with social community platform, where users are able to download their progress on social media, connect with other users, build and join different health and fitness communities that generate discussions and encourage competition amongst users across different regions of the globe. The wearable fitness-monitoring device 100 is plugged into a computer to sync and transfer data, the display unit 140 and the function keys 114 may be illuminated to indicate a syncing process. The wearable fitness-monitoring device 100 further comprises a power unit, which is rechargeable when the communication interface 150 is plugged into the user's computer.

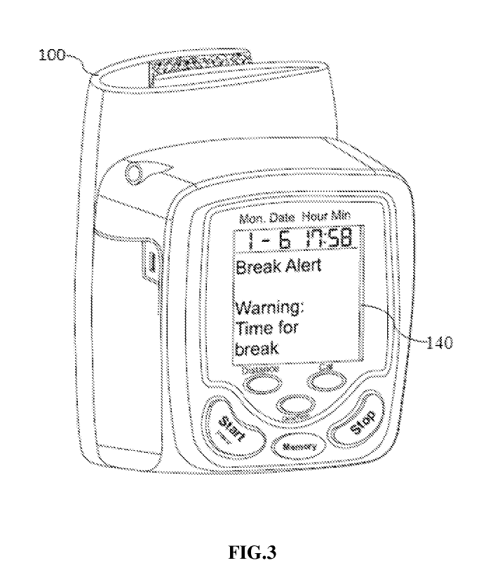

FIG. 3 illustrates the wearable fitness-monitoring device 100 displaying a break alert in the display unit 140. The wearable fitness-monitoring device 100 may automatically suggest a user for taking break based on the factors such as age, weight, duration of activity, heart rate and other predefined settings set by the user. The wearable fitness-monitoring device 100 is programmed to automatically calculate and make individualized plans or suggestions on the duration of activity, mileage or distance to be covered, target zone for heart rate, endurance limit and like. For example, if the user did not achieve a previously set goal, the wearable fitness-monitoring device 100 might provide suggestions to achieve the previously set goal.

The device 100 automatically suggests plans to achieve one or more goals set by the user. For example, if the user's goal is to train for a marathon event, the wearable fitness-monitoring device 100 may define a workout plan based on the goal and suggests the user to time a break, based on the user's performance level and goal for that particular day. The device 100 help the user reach a level of endurance and stamina that will allow user to achieve the goal.

The wearable fitness-monitoring device 100 comprises display unit 140 that may include a display for providing a visual output. In one embodiment, the visual output is responsive to heart rate data, calorie data, GPS information such as location, map, and speed calculated based on time and distance. The display unit 140 may further include multiple sub-displays capable of displaying different types of measured information or displaying the same measured information in different ways, as described in further detail below. The visual display capable of displaying alphanumerical information along with units of measurement such as distance in mile or km, calories in Kcal, time in minutes: seconds, heart rate in beats per minute. The display unit 140 may be capable of displaying information with color code differentiation. The wearable fitness-monitoring device 100 is designed to aid people to develop a motivated and self-supervised healthy lifestyle through regularly tracked athletic, health and fitness routines.

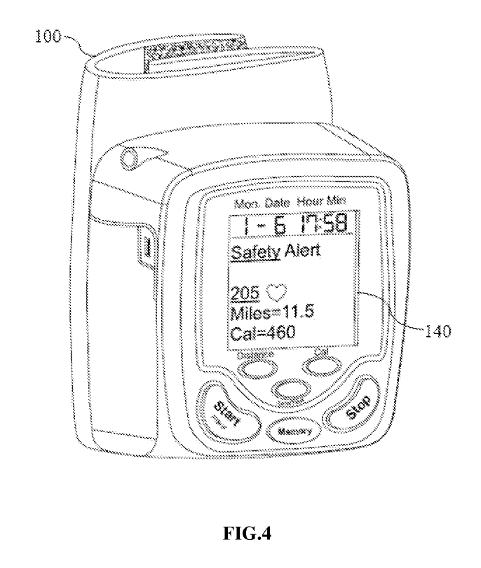

According to another embodiment, FIG. 4 shows the wearable fitness-monitoring device 100 displaying a safety alert on the display unit 140, to inform the user about impending health risks during the athletic or physical or fitness activity. As shown in FIG. 4, one of the third data 122 provided by the controller 120 by processing the first data 108 and second data 110, comprises safety alerts. The threshold level is either defined by the user or automatically assigned based on the user profile such as age, weight and physiological parameters like heart rate, blood pressure.

In an example, If the wearable fitness monitoring device 100 senses that the heart rate of the user exceeds a threshold of maximum heart rate, a safety alert message may be delivered to the display 140 or via the audio interface to warn the user to slow down the physical or fitness activity. The safety alert message comprises various types of audio or text based alerts intended to warn the user regarding abnormal vital signs or drastic change in physiological parameters. The safety alert is notified to the user when the second data 110 comprising one or more physiological parameter such as heart rate, blood pressure and oxygen consumption exceeds a predetermined threshold level. The safety alert is illustrated by an example in FIG. 4. The safety alert may be a sound or audio warning to the user to stop the physical activity. The language preference options are set by the user. In some instances, based on the predetermined threshold and sensed third data 122, the safety alert comprises a vibrational alert to warn user about a risk level of the second data 110. If the threshold exceeds the predetermined level, then safety alert notifies the user with an audio siren along with a red colored display screen. The controller 120 activates a self-shut mode for automatically shutting down the whole device when the safety alerts are ignored by the user.

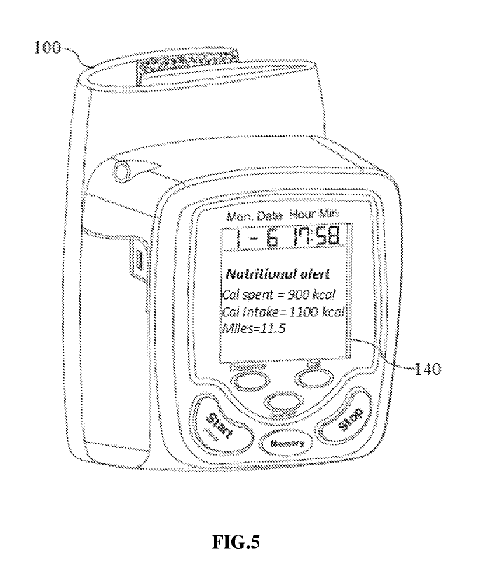

As further shown in FIG. 5, the wearable fitness monitoring device 100 notification alerts may be audio, visual display and vibration. The alert duration may be preset by the user. The controller issues the nutritional alert, for ex: amount of calorie the user should intake and it is calculated based on the amount of calories burned by the user, which is calculated by the controller based on the first data and second data. For example, in the display unit 140 during the user physical activity such as running 11.5 miles, the device suggests calorie intake required=110 kcal which is calculated based on calories spent=900 kcal.

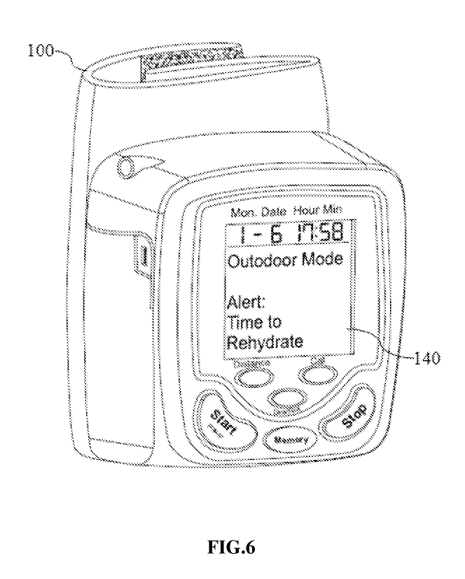

Referring to FIG. 6, the wearable fitness-monitoring device 100 displaying a hydration alert. Based on the user settings, the wearable fitness-monitoring device 100 can function in two modes, the first mode is an indoor mode and the second mode is an outdoor mode. The display 140 shows hydration alert, which informs the user to rehydrate. The hydration alert is calculated by the controller of the device, based on duration of activity, age, weight, sex of the user.

The device 100 uses the self-activated onboard motivational voice challenger and real time progress trackers, the device 100 solves the problem of lack of motivation in setting and accomplishing routine individualized athletic and health and fitness goals. The voice activation can be chosen between male and female voice. The display unit 140 displays the user physical activity metric upon activating start button displaying an indication of an amount of progress of the user towards a goal, wherein the goal is defined based on the user settings.

In an example, the heart rate can be measured and visually displayed in the screen 140 in the range bpm (beats per minute); for ex: 78 [symbol] . The maximum heart rate value is determined prior to beginning a physical activity by the wearable fitness monitoring device 100. During the health and fitness activities, the current heart rate relative to the maximum heart rate can be measured and displayed in the display 140. The functional keys 114 are used for various actions including from start, stop and store the measured data values. The display 140 shows the date and time in a month-data-hour-min format.

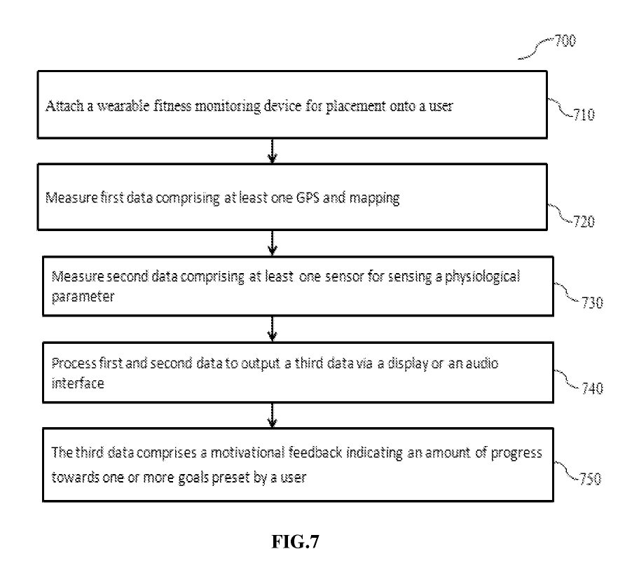

Referring to FIG. 7, a method of wearable fitness monitoring device 700 comprises an operational block 710 of attaching wearable fitness-monitoring device 710 for placement onto a user. The method further comprises an operational block 720 of supplying or measuring the first parameter using GPS and mapping data 720. The method also comprises an operational block 730 of supplying or measuring the second parameter from at least one sensor which is a physiological parameter. The method additionally comprises an operational block 740 of supplying the first and second data to the controller determining a third data of the wearable fitness monitoring device. The method also comprises an operational block 750 of using the third data to calculate the condition and provide a motivational feedback/alert indicating an amount of progress towards one or more goals preset by a user.

The present invention includes several different embodiments having a variety of different features as disclosed herein. It is understood that additional embodiments within the scope of the invention are possible that may utilize a combination of the various different features of the embodiments disclosed herein.

While the invention has been described with respect to specific examples including presently preferred modes of carrying out the invention, those skilled in the art will appreciate that there are numerous variations and permutations of the above described systems and methods. For example, various aspects of the invention may be used in different combinations and various different sub combinations of aspects of the invention may be used together in a single system or method without departing from the invention. In one example, software and applications described herein may be embodied as computer readable instructions stored in computer readable media. Also, various elements, components, and/or steps described above may be changed, changed in order, omitted, and/or additional elements, components, and/or steps may be added without departing from this invention. Thus, the invention should be construed broadly as set forth in the appended claims.

What is claimed is:

1. A wearable fitness monitoring device, the device comprising:
a portable housing attached to a cuff wearable during a physical activity, the housing comprising:
a mapping and GPS system configured to determine a first data;
at least one sensor for sensing a second data comprising physiological parameters;
a controller configured to process the first and second data to output third data via a display unit or an audio interface;
wherein the third data comprises:
i) a safety alert when the second data exceeds a predetermined threshold level;
ii) a motivational message based on the first data;
iii) a nutrition alert suggesting an amount of calorie intake.

2. The wearable fitness monitoring device of claim 1, wherein the third data further comprises a break alert indicating a time for break in between fitness activities.

3. The wearable fitness monitoring device of claim 1, wherein the physiological parameter comprises heart rate, blood pressure and oxygen consumption.

4. The wearable fitness monitoring device of claim 1, wherein the first data comprises distance, time, speed and route.

5. The wearable fitness monitoring device of claim 1, further comprises a plurality of control buttons for inputting user settings.

6. The wearable fitness monitoring device of claim 1, wherein the motivational message indicates an amount of progress towards a goal, wherein the goal is defined based on user settings.

7. The wearable fitness monitoring device of claim 1, further comprises a communication interface configured to transmitting the first data and second data through a wired or wireless means of communication to an external device.

8. The wearable fitness monitoring device of claim 7, wherein the external device comprises a server, a mobile device, a smartphone, a media content player, a personal digital assistant (PDA) and a personal computer.

9. The wearable fitness monitoring device of claim 1, wherein the safety alert comprises an audio alert warning to stop the physical activity.

10. The wearable fitness monitoring device of claim 1, wherein the safety alert comprises a vibrational alert to warn user about a risk level of the second data.

11. The wearable fitness monitoring device of claim 1, wherein the safety alert comprises an audio siren along with a red colored display screen.

12. The wearable fitness monitoring device of claim 1, wherein controller is further configured to activate a self-shut mode for the device to automatically shut down when the safety alerts are ignored by the user.

13. The wearable fitness monitoring device of claim 1, wherein the third data further comprises a hydration alert which informs the user to rehydrate.

14. A method for providing motivational feedback by a wearable fitness monitoring device during a physical activity, the method comprising the steps of:
determining a first data based on a mapping and GPS system of the device;
monitoring a second data based on at least one sensor for sensing a physiological parameter; and
processing the first and second data to output a third data via a display or an audio interface; wherein the third data comprises a motivational feedback indicating an amount of progress towards one or more goals preset by a user.

15. The method of claim 14, wherein the second data comprises heart rate, blood pressure and oxygen consumption.

16. The method of claim 14, wherein the first data comprises distance, time, speed and route.
